(19) United States
(12) Patent Application Publication
(10) Pub. No.: US 2023/0300231 A1
(43) Pub. Date: Sep. 21, 2023

(54) APPARATUS FOR ENABLING INTERCHANGEABLE DETACHABLE ATTACHMENT

(71) Applicant: Marshall Gause, Thornton, CO (US)

(72) Inventor: Marshall Gause, Thornton, CO (US)

(21) Appl. No.: 18/072,055

(22) Filed: Nov. 30, 2022

Related U.S. Application Data
(60) Provisional application No. 63/320,497, filed on Mar. 16, 2022.

(51) Int. Cl. H04M 1/21; F16B 45/02; B25F 1/00

(52) U.S. Cl. CPC H04M 1/21; F16B 45/02; B25F 1/00

(57) ABSTRACT

The present disclosure provides an apparatus. The apparatus includes a base element. In addition, the apparatus includes one or more first holders. The one or more first holders is positioned anywhere around periphery of the base element. Further, the apparatus includes one or more second holders. The one or more second holders is positioned anywhere around periphery of the base element. Furthermore, one or more earphones is detachably attached to the one or more first holders and one or more carabiners is detachably attached to the one or more second holders. Moreover, the one or more first holders and the one or more second holders may be used interchangeably for detachably attaching the one or more earphones and the one or more carabiners and vice versa.

### TECHNICAL FIELD

The present invention relates to the field of apparatuses, in particular, relates to an apparatus having interchangeable detachable attachment.

### BACKGROUND

It has become common in the past few years for users to use cell phones. Today's cell phones are becoming increasingly technically complex and often include components and applications that allow users to perform tasks other than simple voice communication with other users. These days, users often attach accessories with their cell phone, which enables the cell phone to temporarily attach to multiple external equipment, such as, key holder, spinning accessory, protective covers or cases. Only one external equipment can be installed and/or carry once at a time which makes it difficult to use and/or carry the multiple external equipment at once. For example, the case of the cell phone can attach or carry only earphones, but it is difficult to attach or carry the carabiner hook along with the earphones at once. In another example, it is not disclosed to interchangeably use the carabiner hooks and the earphones. In yet another example, it is difficult to tightly hold the carabiner hook against the case of the phone. Also, current accessory of the cell phone does not have the provision or equipment to charge the earphones.

In light of the foregoing discussion, there exists a need for a novel apparatus which overcomes the above-cited drawbacks.

### SUMMARY

Aspects and advantages of embodiments of the present disclosure will be set forth in part in the following description, or can be learned from the description, or can be learned through practice of the embodiments.

One example aspect of the present disclosure is directed to an apparatus. The apparatus includes a base element. In addition, the apparatus includes one or more first holders. The one or more first holders is positioned anywhere around periphery of the base element. Further, the apparatus includes one or more second holders. The one or more second holders is positioned anywhere around periphery of the base element. Furthermore, one or more earphones is detachably attached to the one or more first holders and one or more carabiners is detachably attached to the one or more second holders. Moreover, the one or more first holders and the one or more second holders may be used interchangeably for detachably attaching the one or more earphones and the one or more carabiners and vice versa.

In an embodiment of the present disclosure, the base element may be a phone case.

In an embodiment of the present disclosure, the base element may be a wallet.

In an embodiment of the present disclosure, the apparatus may include one or more third holders for detachably attaching one or more clipable rechargeable battery pack. In addition, the one or more third holders may be positioned anywhere around periphery of the base element or the one or more carabiners. Further, the one or more clipable rechargeable battery pack may be used for charging at least one of the one or more earphones, a computing device, and one or more electronic devices.

In an embodiment of the present disclosure, the apparatus may include one or more fourth holders for detachably attaching one or more multi-tool devices. In addition, the one or more fourth holders may be positioned anywhere around periphery of the base element.

In an embodiment of the present disclosure, the apparatus may include one or more tracking modules detachably attached to at least one of the base element, the one or more carabiners, the one or more earphones and one or more multi-tool devices. In addition, the one or more tracking modules may be positioned anywhere around periphery of the base element.

In an embodiment of the present disclosure, the apparatus may include an extendable holding stand detachably attached to the base element. In addition, the extendable holding stand may be positioned anywhere around periphery of the base element.

In an embodiment of the present disclosure, the one or more carabiners may hold the apparatus tightly. In addition, the one or more carabiners may be in continuous contact with the base element of the apparatus when not in use by a user.

In an embodiment of the present disclosure, the one or more carabiners may hold the apparatus tightly using a leverage.

In an embodiment of the present disclosure, the one or more carabiners may hold the apparatus tightly using friction of at least one of a spring, and a rubber.

In an embodiment of the present disclosure, the one or more carabiners may hold the apparatus tightly using a magnet.

In an embodiment of the present disclosure, the one or more carabiners may include one or more multi-tool features. In addition, the one or more multi-tool features include at least one of a bottle opener, a tank wrench, a multi-socket, etched rulers, a strap holder, a blade, a Phillips-type screwdriver head, a flat-head type screwdriver head, a torx type screwdriver head, a flint, a tank wrench, a holder for an AirTag tracker device, a serrated edge, a replaceable utility blade and or strap holder.

In an embodiment of the present disclosure, the one or more carabiners may be attached to other one or more carabiners.

In an embodiment of the present disclosure, the one or more carabiners may be designed with a rounded or curved area for finger-holding support comfort.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Having thus described the invention in general terms, reference will now be made to the accompanying drawings, which are not necessarily drawn to scale, and wherein:

FIG. 1 illustrates a perspective view of a first exemplary apparatus, in accordance with various embodiments of the present disclosure;

FIG. 2 illustrates a perspective view of a second exemplary apparatus, in accordance with various embodiments of the present disclosure;

FIG. 3 illustrates a perspective view of a third exemplary apparatus, in accordance with various embodiments of the present disclosure;

FIG. 4 illustrates a perspective view of a fourth exemplary apparatus, in accordance with various embodiments of the present disclosure;

FIG. 5 illustrates a perspective view of a fifth exemplary apparatus, in accordance with various embodiments of the present disclosure;

FIG. 6 illustrates a perspective view of a sixth exemplary apparatus, in accordance with various embodiments of the present disclosure;

FIG. 7 illustrates a perspective view of a seventh exemplary apparatus, in accordance with various embodiments of the present disclosure;

FIG. 8 illustrates a perspective view of an eighth exemplary apparatus, in accordance with various embodiments of the present disclosure;

FIG. 9 illustrates a perspective view of a ninth exemplary apparatus, in accordance with various embodiments of the present disclosure; and

FIG. 10 illustrates a perspective view of a tenth exemplary apparatus, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure.

It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

An apparatus is a type of device that has interchangeable and dynamic functions into a single unit for holding two or more elements. The apparatus may be used by any user. The user may include but not limited to an individual, a mechanic, a carpenter, a mountaineer, a backpacker, a trekker, a hiker, a technician, a repairman, and a serviceman.

The apparatus includes a base element. In an embodiment of the present disclosure, the base element is a phone case. In an example, the base element is an iPhone case. In another example, the base element is an android phone case. In yet another example, the base element is a basic phone case. In yet another embodiment of the present disclosure, the base element is a feature phone case. In yet another embodiment of the present disclosure, the base element is a smartphone case. In another embodiment of the present disclosure, the base element is a wallet. Generally, the base element wallet may additionally include one or combination of a credit card eject button, RFID (radio-frequency identification) blocking, and an embedded air tracker holder used in conjunction with the elements listed with the apparatus. In an example, the base element is a Bifold wallet. In another example, the base element is a trifold wallet. In yet another example, the base element is a credit card wallet. In yet another example, belt wallet. In yet another example, the basic element is a cell phone wallet. The basic element may be of any shape and size.

The base element is made of a first material. In addition, the first material is selected from a group of materials including thermoplastic polyurethane, polycarbonate, acrylonitrile butadiene styrene, polyvinyl chloride, polypropylene, plastic, rubber, metallic materials, alloys, composites, nylon, leather, silicon, and wood. In an embodiment of the present disclosure, the base element is made of the thermoplastic polyurethane. In another embodiment of the present disclosure, the base element is made of any suitable material.

In an example, the base element of the apparatus is made of the polycarbonate. In another example, the base element of the apparatus is made of the acrylonitrile butadiene styrene. In yet another example, the base element of the apparatus is made of the polyvinyl chloride. In yet another example, the base element of the apparatus is made of the polypropylene. In yet another example, the base element of the apparatus is made of the natural rubber. In yet another example, the base element of the apparatus is made of the synthetic rubber. In yet another example, the base element of the apparatus is made of the silicon. In yet another example, the base element of the apparatus is made of the leather. In yet another example, the base element of the apparatus is made of the metallic alloy.

The apparatus includes one or more first holders. In addition, the one or more first holders is positioned anywhere around periphery of the base element. Further, one or more earphones is detachably attached to the one or more first holders. Furthermore, the one or more first holders allows the one or more earphones to be detachably connected to the base element of the apparatus. Moreover, the one or more first holders may be detachably positioned anywhere around the base element using any of one or more chemical adhesives, one or more mechanical means and one or more tapes. In an example, the one or more first holders is affixed or attached to the base element of the apparatus using the one or more mechanical means (Let's say nuts and bolts). In another example, the one or more first holders is affixed or attached to the base element of the apparatus using the one or more mechanical means (Let's say screws). In yet another example, the one or more first holders is affixed or attached to the base element of the apparatus using the one or more mechanical means (Let's say pins and rivets). In yet another example, the one or more first holders is affixed or attached to the base element of the apparatus using the one or more chemical adhesives (Let's say Epoxy adhesives).

The apparatus includes one or more second holders. In addition, the one or more second holders is positioned anywhere around periphery of the base element. Further, one or more carabiners is detachably attached to the one or more second holders. Furthermore, the one or more second holders allows the one or more carabiners to be detachably connected to the base element of the apparatus. Moreover, the one or more second holders may be detachably positioned anywhere around the base element using any of one or more chemical adhesives, one or more mechanical means and one or more tapes. In an example, the one or more second holders is affixed or attached to the base element of the apparatus using the one or more mechanical means (Let's say nuts and bolts). In another example, the one or more second holders is affixed or attached to the base element of the apparatus using the one or more mechanical means (Let's say screws). In yet another example, the one or more second holders is affixed or attached to the base element of the apparatus using the one or more mechanical means (Let's say pins and rivets). In yet another example, the one or more second holders is affixed or attached to the base element of the apparatus using the one or more chemical adhesives (Let's say Epoxy adhesives).

The apparatus has a feature using which the one or more first holders and the one or more second holders may be used interchangeably for detachably attaching the one or more earphones and the one or more carabiners and vice versa. For example, a user A (Let's say Adam) may use a first holder (which is used for the earphones) to detachably attach a carabiner hook. In another example, a user J (Let's say Jules) may use a second holder (which is used for the carabiners) to detachably attach Air pods.

The apparatus may include one or more third holders. In addition, the one or more third holders may be positioned anywhere around periphery of the base element. Further, one or more clipable rechargeable battery pack may be detachably attached to the one or more third holders. Furthermore, the one or more third holders may allow the one or more clipable rechargeable battery pack to be detachably connected to the base element of the apparatus. Moreover, the one or more third holders may be detachably positioned anywhere around the base element using any of one or more chemical adhesives, one or more mechanical means and one or more tapes. In an example, the one or more third holders may be affixed or attached to the base element of the apparatus using the one or more mechanical means (Let's say nuts and bolts). In another example, the one or more third holders may be affixed or attached to the base element of the apparatus using the one or more mechanical means (Let's say screws). In yet another example, the one or more third holders may be affixed or attached to the base element of the apparatus using the one or more mechanical means (Let's say pins and rivets). In yet another example, the one or more third holders may be affixed or attached to the base element of the apparatus using the one or more chemical adhesives (Let's say Epoxy adhesives). The one or more clipable rechargeable battery pack may be used for charging at least one of the one or more earphones, a computing device, and one or more electronic devices.

The apparatus may include one or more fourth holders. In addition, the one or more fourth holders may be positioned anywhere around periphery of the base element. Further, one or more multi-tool devices may be detachably attached to the one or more fourth holders. Furthermore, the one or more fourth holders may allow the one or more multi-tool devices to be detachably connected to the base element of the apparatus. Moreover, the one or more fourth holders may be detachably positioned anywhere around the base element using any of one or more chemical adhesives, one or more mechanical means and one or more tapes. In an example, the one or more fourth holders may be affixed or attached to the base element of the apparatus using the one or more mechanical means (Let's say nuts and bolts). In another example, the one or more fourth holders may be affixed or attached to the base element of the apparatus using the one or more mechanical means (Let's say screws). In yet another example, the one or more fourth holders may be affixed or attached to the base element of the apparatus using the one or more mechanical means (Let's say pins and rivets). In yet another example, the one or more fourth holders may be affixed or attached to the base element of the apparatus using the one or more chemical adhesives (Let's say Epoxy adhesives). The one or more multi-tool devices may include but not limited to a mechanical tool, a fastener, a drive socket, a cork screw, an opening tool, a cutting tool, a shearing tool, and a plier.

The apparatus may include one or more tracking modules. In addition, the one or more tracking modules may be positioned anywhere around periphery of the apparatus. Further, one or more tracking modules may be detachably attached to at least one of the base element, the one or more carabiners, the one or more earphones, and the one or more multi-tool devices. For example, using an AirTag as the tracking module. The one or more tracking modules may be used to assist the user to locate an object like a phone, a phone case, a wallet, a multi-tool device, an earphone, a carabiner hook, a clipable rechargeable battery pack, and the like.

The apparatus may include an extendable holding stand. In addition, the extendable holding stand may be positioned anywhere around periphery of the apparatus. Further, the extendable holding stand may be detachably attached to the base element of the apparatus. The extendable holding stand may enable telescoping tripod attachment feature of the apparatus. The extendable holding stand may serve as a phone camera tri-pod and/or a selfie type stick.

The one or more carabiners may hold the apparatus tightly. In addition, the one or more carabiners may be in continuous contact with the base element of the apparatus when not in use by the user. In an embodiment of the present disclosure, the one or more carabiners may hold the apparatus tightly using a leverage. In another embodiment of the present disclosure, the one or more carabiners may hold the apparatus tightly through friction of at least one of a spring, and a rubber. In yet another embodiment of the present disclosure, the one or more carabiners may hold the apparatus tightly using a magnet. The latch to hold the carabiner may or may not be collapsible. The one or more carabiners may include one or more multi-tool features having at least one of a bottle opener, a tank wrench, a multi-socket, etched rulers, a strap holder, a blade, a Phillips-type screwdriver head, a flat-head type screwdriver head, a torx type screwdriver head, a flint, a tank wrench, a holder for an AirTag tracker device, a serrated edge, a replaceable utility blade and or strap holder. In addition, the one or more carabiners in addition to attaching to the other attachable items such as the iphone case or wallet, a multi-tool, an air tag holder, a key fob holder, wireless ear buds or holder, may attach to other one or more carabiners that is—carabiner to carabiner attachment. Further, the one or more carabiners may be designed with a rounded or curved area for finger-holding support comfort and remainder portion of the carabiner may be designed in a flat shape. The rounded or curved area for finger-holding support comfort is for finger comfort for the user. In an implementation of the present disclosure, the rounded or curved area for finger-holding support comfort may be made by adding a curved rubber part (or similar material) to make that area more comfortable for finger support.

In one implementation of the present disclosure, the apparatus may include a finger holder attached through a magnetic force. The one or more carabiners or the multi-tool carabiners may have attachable loops to hold earphones that may or may not have a protective case. In addition, the apparatus may have a magnetic feature to which the finger holder or the one or more carabiners or the multi-tool device is/are attachable. The multi-tool device or the one or more carabiners may also serve as a stand.

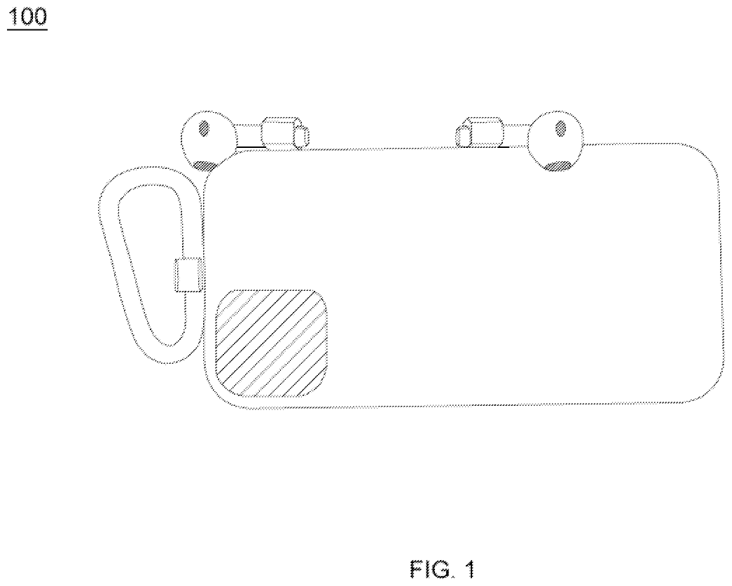

Now referring to FIG. 1, a perspective view of a first exemplary apparatus 100 is illustrated, in accordance with various embodiments of the present disclosure. The first exemplary apparatus 100 includes a base element which is a phone case, an ear phones, and a carabiner hook. In addition, the first exemplary apparatus 100 includes the carabiner hook detachably connected to the phone case of the first exemplary apparatus 100 through a second holder. Further, the first exemplary apparatus 100 includes the ear phones detachably connected to the phone case of the first exemplary apparatus 100 through a first holder.

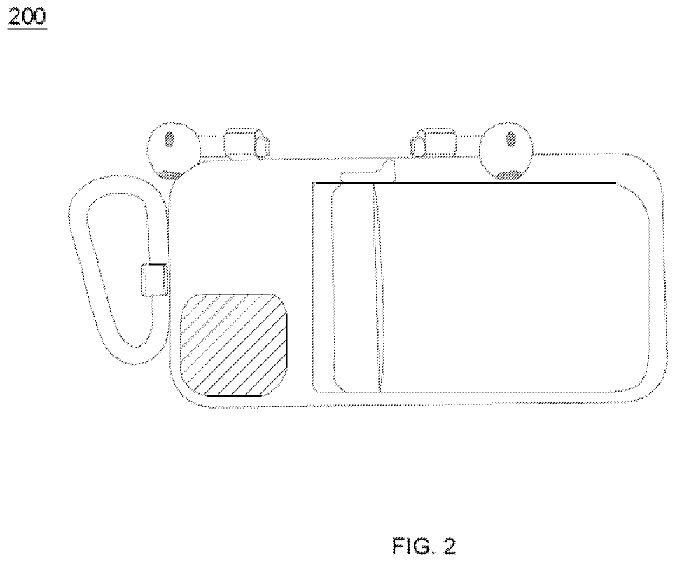

Now referring to FIG. 2, a perspective view of a second exemplary apparatus 200 is illustrated, in accordance with various embodiments of the present disclosure. The second exemplary apparatus 200 includes a base element which is a phone case, an ear phones, a wallet, and a carabiner hook. In addition, the second exemplary apparatus 200 includes the carabiner hook detachably connected to the phone case of the second exemplary apparatus 200 through a second holder. Further, the second exemplary apparatus 200 includes the ear phones detachably connected to the phone case of the second exemplary apparatus 200 through a first holder. Furthermore, the second exemplary apparatus 200 includes the wallet detachably connected to the phone case of the second exemplary apparatus 200 through a Velcro (Not shown in the FIG. 2).

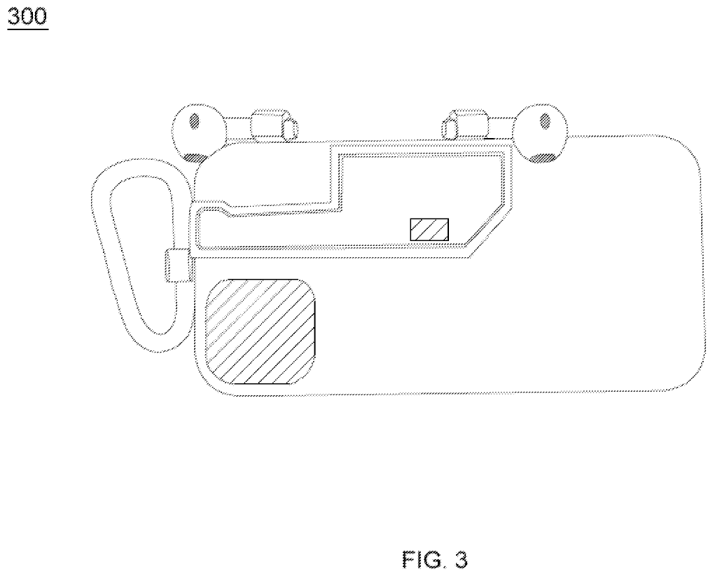

Now referring to FIG. 3, a perspective view of a third exemplary apparatus 300 is illustrated, in accordance with various embodiments of the present disclosure. The third exemplary apparatus 300 includes a base element which is a phone case, an ear phones, a multi-tool device, and a carabiner hook. In addition, the third exemplary apparatus 300 includes the carabiner hook detachably connected to the phone case of the third exemplary apparatus 300 through a second holder. Further, the third exemplary apparatus 300 includes the ear phones detachably connected to the phone case of the third exemplary apparatus 300 through a first holder. Furthermore, the third exemplary apparatus 300 includes the multi-tool device detachably connected to the phone case of the third exemplary apparatus 300 through a fourth holder.

Now referring to FIG. 3, a perspective view of a third exemplary apparatus 300 is illustrated, in accordance with various embodiments of the present disclosure. The third exemplary apparatus 300 includes a base element which is a phone case, an ear phones, a multi-tool device, and a carabiner hook. In addition, the third exemplary apparatus 300 includes the carabiner hook detachably connected to the phone case of the third exemplary apparatus 300 through a second holder. Further, the third exemplary apparatus 300 includes the ear phones detachably connected to the phone case of the third exemplary apparatus 300 through a first holder. Furthermore, the third exemplary apparatus 300 includes the multi-tool device detachably connected to the phone case of the third exemplary apparatus 300 through a fourth holder.

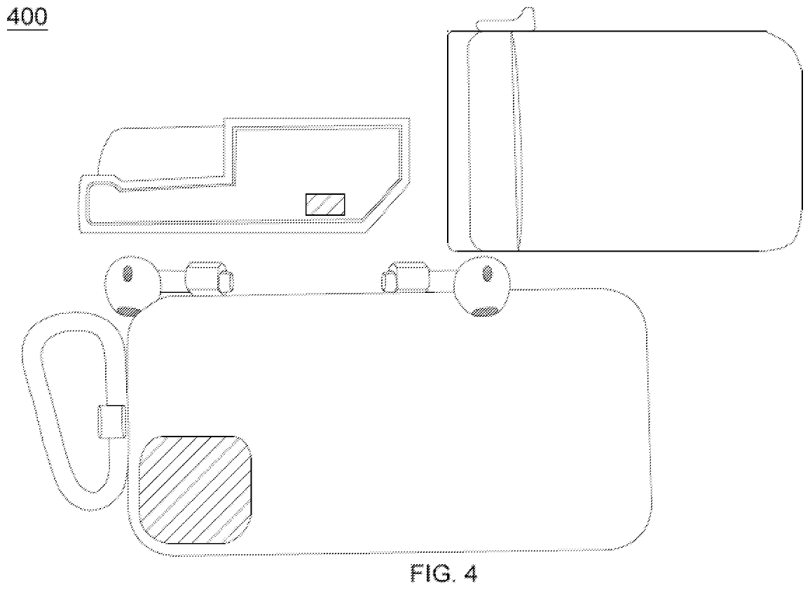

Now referring to FIG. 4, a perspective view of a fourth exemplary apparatus 400 is illustrated, in accordance with various embodiments of the present disclosure. The fourth exemplary apparatus 400 includes a base element which is a phone case, an ear phones, a multi-tool device, a wallet, and a carabiner hook. In addition, the fourth exemplary apparatus 400 includes the carabiner hook detachably connected to the phone case of the fourth exemplary apparatus 400 through a second holder. Further, the fourth exemplary apparatus 400 includes the ear phones detachably connected to the phone case of the fourth exemplary apparatus 400 through a first holder. FIG. 4 includes the wallet and the multi-tool device separately in the exploded view.

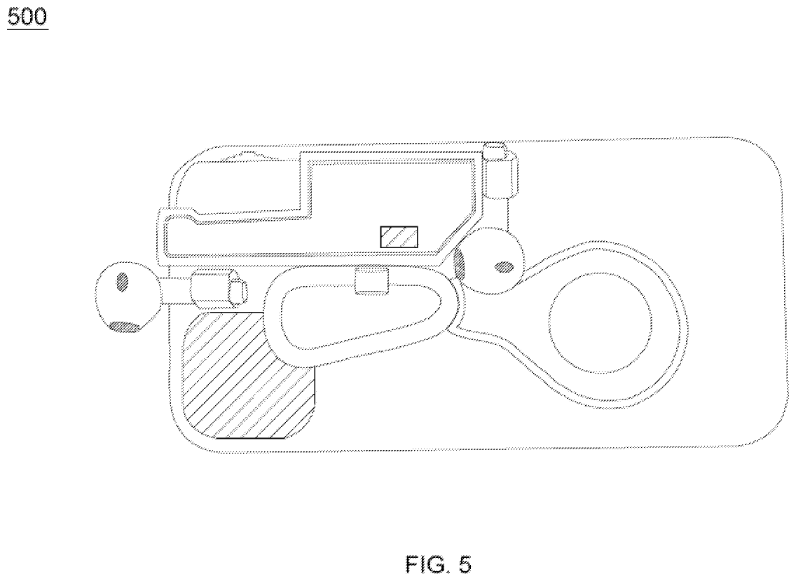

Now referring to FIG. 5, a perspective view of a fifth exemplary apparatus 500 is illustrated, in accordance with various embodiments of the present disclosure. The fifth exemplary apparatus 500 includes a base element which is a phone case, an ear phones, a multi-tool device, a tracking module, and a carabiner hook. In addition, the fifth exemplary apparatus 500 includes the carabiner hook detachably connected to the multi-tool device of the fifth exemplary apparatus 500 through a second holder. Further, the fifth exemplary apparatus 500 includes the ear phones detachably connected to the phone case of the fifth exemplary apparatus 500 through a first holder. Furthermore, the fifth exemplary apparatus 500 includes the multi-tool device detachably connected to the phone case of the fifth exemplary apparatus 500 through a fourth holder. Moreover, the fifth exemplary apparatus 500 includes the tracking module detachably connected to the carabiner hook of the fifth exemplary apparatus 500.

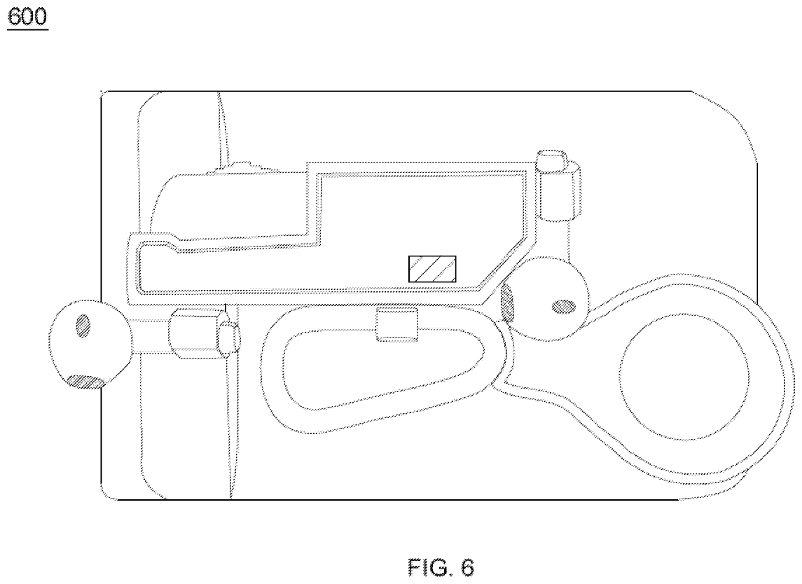

Now referring to FIG. 6, a perspective view of a sixth exemplary apparatus 600 is illustrated, in accordance with various embodiments of the present disclosure. The sixth exemplary apparatus 600 includes a base element which is a wallet, an ear phones, a multi-tool device, a tracking module, and a carabiner hook. In addition, the sixth exemplary apparatus 600 includes the carabiner hook detachably connected to the multi-tool device of the sixth exemplary apparatus 600 through a second holder. Further, the sixth exemplary apparatus 600 includes the ear phones detachably connected to the wallet of the sixth exemplary apparatus 600 through a first holder. Furthermore, the sixth exemplary apparatus 600 includes the multi-tool device detachably connected to the wallet of the sixth exemplary apparatus 600 through a fourth holder. Moreover, the sixth exemplary apparatus 600 includes the tracking module detachably connected to the carabiner hook of the sixth exemplary apparatus 600.

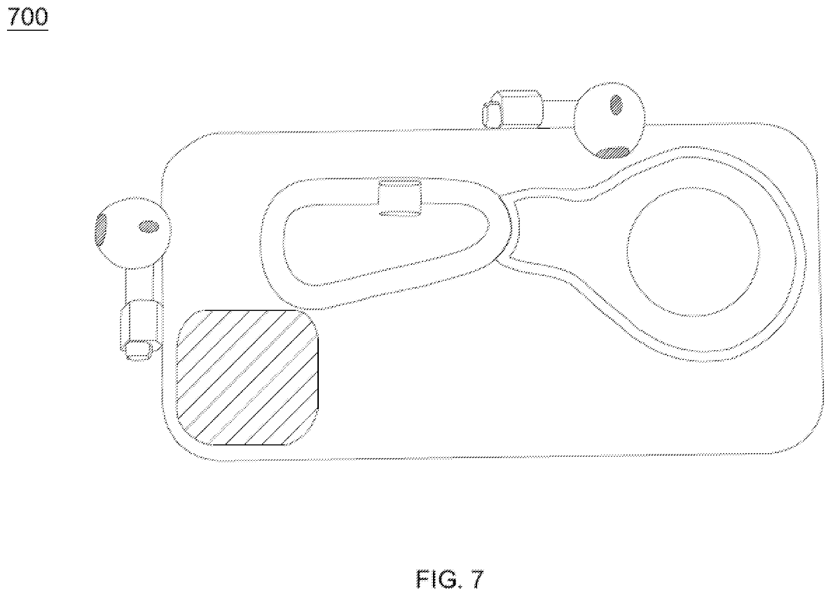

Now referring to FIG. 7, a perspective view of a seventh exemplary apparatus 700 is illustrated, in accordance with various embodiments of the present disclosure. The seventh exemplary apparatus 700 includes a base element which is a phone case, an ear phones, a tracking module, and a carabiner hook. In addition, the seventh exemplary apparatus 700 includes the carabiner hook detachably connected to the phone case of the seventh exemplary apparatus 700 through a second holder. Further, the seventh exemplary apparatus 700 includes the ear phones detachably connected to the phone case of the seventh exemplary apparatus 700 through a first holder. Furthermore, the seventh exemplary apparatus 700 includes the tracking module detachably connected to the carabiner hook of the seventh exemplary apparatus 700.

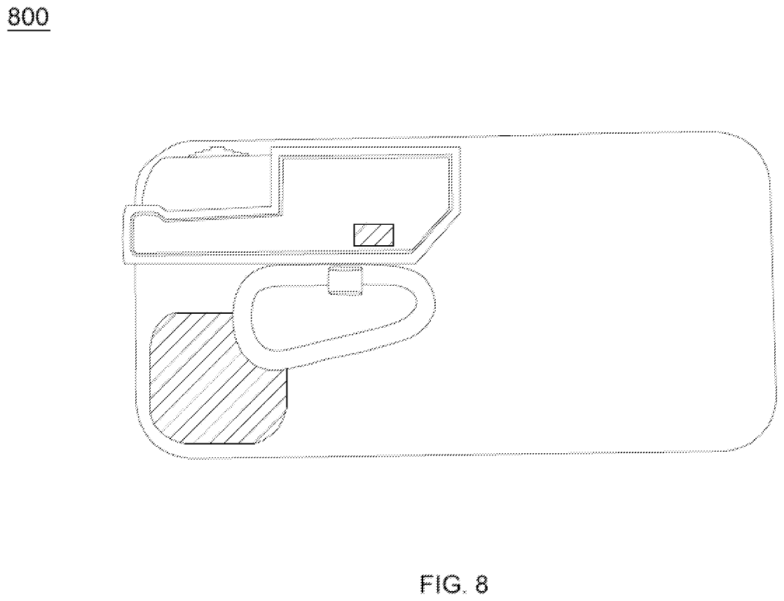

Now referring to FIG. 8, a perspective view of an eighth exemplary apparatus 800 is illustrated, in accordance with various embodiments of the present disclosure. The eighth exemplary apparatus 800 includes a base element which is a phone case, a multi-tool device, and a carabiner hook. In addition, the eighth exemplary apparatus 800 includes the carabiner hook detachably connected to the multi-tool device of the eighth exemplary apparatus 800 through a second holder. Further, the eighth exemplary apparatus 800 includes the multi-tool device detachably connected to the phone case of the eighth exemplary apparatus 800.

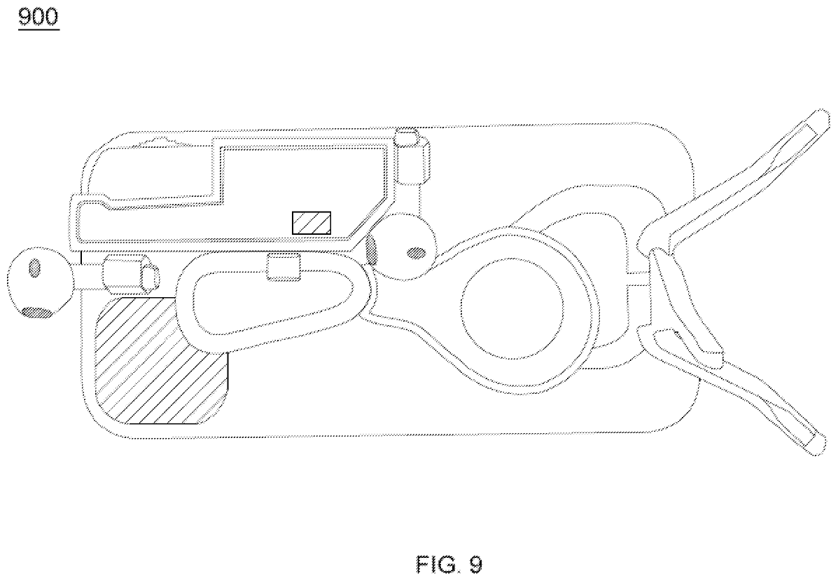

Now referring to FIG. 9, a perspective view of a ninth exemplary apparatus 900 is illustrated, in accordance with various embodiments of the present disclosure. The ninth exemplary apparatus 900 includes a base element which is a phone case, a multi-tool device, an ear phones, a tracking module, an extendable holding stand, and a carabiner hook. In addition, the ninth exemplary apparatus 900 includes the carabiner hook detachably connected to the multi-tool device of the ninth exemplary apparatus 900 through a second holder. Further, the ninth exemplary apparatus 900 includes the multi-tool device detachably connected to the phone case of the ninth exemplary apparatus 900. Furthermore, the ninth exemplary apparatus 900 includes the extendable holding stand (a selfie stick) detachably connected to the phone case of the ninth exemplary apparatus 900.

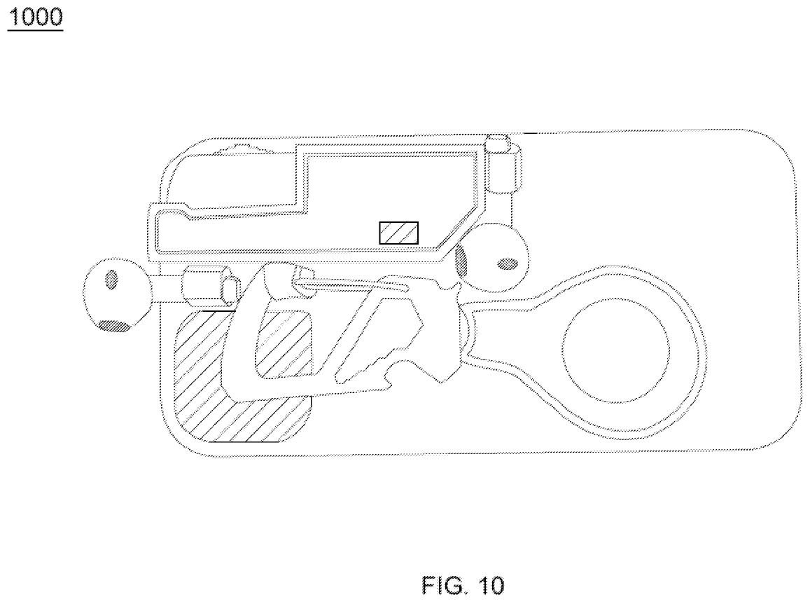

Now referring to FIG. 10, a perspective view of a tenth exemplary apparatus 1000 is illustrated, in accordance with various embodiments of the present disclosure. The tenth exemplary apparatus 1000 includes a base element which is a phone case, a multi-tool device, an ear phones, a tracking module, and a carabiner hook. In addition, the tenth exemplary apparatus 1000 includes the carabiner hook (having a rounded or curved area for finger-holding support comfort) detachably connected to the multi-tool device of the tenth exemplary apparatus 1000 through a second holder. Further, the tenth exemplary apparatus 1000 includes the multi-tool device detachably connected to the phone case of the tenth exemplary apparatus 1000.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

I claim:

1. An apparatus, comprising:
a base element;
one or more first holders, wherein the one or more first holders is positioned anywhere around periphery of the base element; and
one or more second holders, wherein the one or more second holders is positioned anywhere around periphery of the base element,
wherein one or more earphones is detachably attached to the one or more first holders and one or more carabiners is detachably attached to the one or more second holders; and
wherein the one or more first holders and the one or more second holders may be used interchangeably for detachably attaching the one or more earphones and the one or more carabiners and vice versa.

2. The apparatus as recited in claim 1, wherein the base element may be a phone case.

3. The apparatus as recited in claim 1, wherein the base element may be a wallet.

4. The apparatus as recited in claim 1, wherein the apparatus may comprise one or more third holders for detachably attaching one or more clipable rechargeable battery pack, wherein the one or more third holders is positioned anywhere around periphery of the base element or the one or more carabiners, wherein the one or more clipable rechargeable battery pack may be used for charging at least one of the one or more earphones, a computing device, and one or more electronic devices.

5. The apparatus as recited in claim 1, wherein the apparatus may comprise one or more fourth holders for detachably attaching one or more multi-tool devices, wherein the one or more fourth holders is positioned anywhere around periphery of the base element.

6. The apparatus as recited in claim 1, wherein the apparatus may comprise one or more tracking modules detachably attached to at least one of the base element, the one or more carabiners, the one or more earphones and one or more multi-tool devices, wherein the one or more tracking modules is positioned anywhere around periphery of the base element.

7. The apparatus as recited in claim 1, wherein the apparatus may comprise an extendable holding stand detachably attached to the base element, wherein the extendable holding stand is positioned anywhere around periphery of the base element.

8. The apparatus as recited in claim 1, wherein the one or more carabiners holds the apparatus tightly, wherein the one or more carabiners is in continuous contact with the base element of the apparatus when not in use by a user.

9. The apparatus as recited in claim 1, wherein the one or more carabiners may hold the apparatus tightly using a leverage.

10. The apparatus as recited in claim 1, wherein the one or more carabiners may hold the apparatus tightly using friction of at least one of a spring, and a rubber.

11. The apparatus as recited in claim 1, wherein the one or more carabiners may hold the apparatus tightly using a magnet.

12. The apparatus as recited in claim 1, wherein the one or more carabiners may comprise one or more multi-tool features having at least one of a bottle opener, a tank wrench, a multi-socket, etched rulers, a strap holder, a blade, a Phillips-type screwdriver head, a flat-head type screwdriver head, a torx type screwdriver head, a flint, a tank wrench, a holder for an AirTag tracker device, a serrated edge, a replaceable utility blade and or strap holder.

13. The apparatus as recited in claim 1, wherein the one or more carabiners may be attached to other one or more carabiners.

14. The apparatus as recited in claim 1, wherein the one or more carabiners may be designed with a rounded or curved area for finger-holding support comfort.
